(19) United States
(12) Patent Application Publication
(10) Pub. No.: US 2014/0372425 A1
(43) Pub. Date: Dec. 18, 2014

(54) PERSONALIZED SEARCH EXPERIENCE BASED ON UNDERSTANDING FRESH WEB CONCEPTS AND USER INTERESTS

(71) Applicant: Microsoft Corporation, Redmond, WA (US)

(72) Inventors: Dina Ayoub, Redmond, WA (US); Junaid Ahmed, Bellevue, WA (US)

(21) Appl. No.: 13/917,886

(22) Filed: Jun. 14, 2013

(51) Int. Cl. G06F 17/30

(52) U.S. Cl. CPC G06F 17/3053
USPC 707/727

(57) ABSTRACT

Architecture that employs a search engine to unobtrusively understand the concepts (topics) and entities in which a user is interested, while simultaneously understanding the current events of the world. These concepts/entities and current events are then mapped to each other to provide a personalized experience for each user that is informative as to the latest news of interest to the user. The user interests are mapped to current events, and queries are formulated, ranked, and displayed to the user that relate to what the user may be interested in searching about new events the user would not have considered without the search engine's assistance. The popular queries are combined with the understanding of what is being indexed in a super fresh tier to determine the current events.

### BACKGROUND

It is difficult for a user to discover what is happening in the world that is of interest without investing valuable time and effort. Moreover, users are bombarded by a multitude of irrelevant news in which the user has no interest. Current solutions have a combination of problems: lack of personalization—being too broad in several categories rather than specific interests; tediousness—too much effort/time required for setup; lack of discoverability—there are so many readers and news sites unfamiliar to the user and not integrated into an existing experience; and, lack of portability across devices and platforms—many of these solutions are only designed for one platform or another. There is no solution that understands the entities of interest to the user without requiring elaborate setup and configuration.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture employs a search engine to unobtrusively understand the concepts (topics) and entities in which the user is interested, while simultaneously understanding the current events of the world. These concepts/entities and current events are then mapped to each other to provide a personalized experience for each user that is informative as to the latest news of interest to the user. This need not be provided as a separate service (although it can be), but as part of the user's search experience.

A knowledge base of about a given user is used to identify and understand specific interests of the user in terms of entities or concepts, such as the celebrities of interest, the technologies of interest, politicians to follow, etc., using all available data sources such as search history, browsing history, social networking activity (e.g., user actions on social websites such as “likes”, comments, and messages) compiled from the user's social graph. The knowledge base can be developed as part of the search engine, and/or unrelated to the search engine at all. In one implementation, the search engine employs the capability to understand the current events only and the knowledge base is obtained (derived) from user browsing history, social network activity, and so on.

The importance of these entities to the user can be ranked by frequency and a measure of relatedness. For example, if the search is for multiple items in one particular geographical location such as a neighborhood, even though the queries are different and do not mention the neighborhood by name, it can be deduced that the user has increased interest in that neighborhood because the searches are related to one another through this neighborhood entity. Thus, a user's single search for a specific location does not necessarily mean the location is identified as an interest; however, multiple queries about related entities may indicate strength (or importance) of the interest. Other indicators of strength of interest can include browsing history, comments, “likes” on a social network, and click-through rates, for example.

The disclosed architecture utilizes the understanding of concepts by the search engine to analyze current events and match the current events to concepts (topics) and entities. The popular queries are combined with the understanding of what is being indexed in a super fresh tier (e.g., from seconds ago) to determine the current events. The importance of the information being indexed can also be ranked through clustering of the information (using commonly-known clustering algorithms) to understand the “breaking news”, for example, that many websites are discussing, as opposed to a single user's latest blog post.

The user interests are mapped to current events, queries can be formulated and top event items ranked and displayed to the user that relate to what the user may be interested in searching about new events the user would not have considered without the search engine's assistance. It can be the case that only the top events are displayed, and also the case that these top events are presented regularly to the user. Moreover, the user can modify the associated user interests or exclude concepts, as an option. This is similar to deleting items from the user search history if the user believes items of the search history are not relevant.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a system that facilitates a personalized search experience.

FIG. 3 illustrates an example of a personalized search experience in accordance with the disclosed architecture.

FIG. 4 illustrates a method in accordance with the disclosed architecture.

FIG. 5 illustrates an alternative method in accordance with the disclosed architecture.

FIG. 6 illustrates a block diagram of a computing system that generates and executes identification of user interests and matching events for a personalized search experience in accordance with the disclosed architecture.

### DETAILED DESCRIPTION

End users have varying and very specific interests that are currently not being captured or offered anywhere. Current attempted solutions involve two categories. A first category involves RSS (really simple syndication) news feed readers, which collect data from multiple sources specified by the user. For example, a user first finds an RSS news feed reader, which may be different from device to device. The user then chooses trusted news websites, and finds the RSS feeds offered by those websites in which the user is most interested (which tend to be very broad categories such as “Sports”, “Politics”, “The Middle East”, etc.). The user is not given the ability at this point to further narrow the categories to the user's more specific interests. Rather, the user is presented with myriad options to choose from, as most websites offer RSS feeds. The user is then faced with expending an inordinate amount of forethought and effort to configure the feed, and thereafter, the user receives a large number of results most of which are non-relevant or of not interest.

In a second category, an existing news vendor approaches personalization by allowing the user to enter specific search keywords, and then adds the keywords to the vendor news feed (which is similar to RSS feeds except the vendor news feed is not website specific, but are basically running searches and returning only news articles). The problem with category is again, the requirement of an inordinate amount of effort and setup time to think of all the keywords the person is interested in, enter the keywords, and adjust the results and the keywords to the user's liking. Moreover, the user has to navigate specifically to this website (an obscure and unfamiliar website) so there is a discoverability problem, and in addition, this approach does not cover all kinds of media thereby ignoring blogs by or about a certain person.

Given the amount of knowledge obtained/obtainable about users, the disclosed architecture utilizes this knowledge to determine content a user considers of interest in very specific terms such as entities, topics, and concepts, and automatically displays relevant information to the user in an unobtrusive way (without the user requesting it, although this can be enabled).

This encourages return visits, both to view the data and to help the search engine increase its knowledge about user interest. This has a transforming effect in the way search engines are being used—it no longer is about what the user is currently looking for, but what the user cares about, in general.

For example, rather than navigating to a news reader (e.g., an RSS feed), a news aggregation website, or multiple websites that categorize information based on very broad categories such as “sports” and “politics”, search engine users will now have a way to learn about what is happening in the world with regards to precisely what they care about, without wading through information that is of no interest.

No existing service currently offers this level of automatic personalization—personal interests that are much more entity-based. As the search engine processes searches for a given user, the search engine automatically learns about the user—no further input is required. Additionally, rather than a search engine only telling the user about what's trending in general and which may not be of interest, the search engine now focuses more on the user's interests (a discovery tool). This affords the search engine provider the capability to utilize fresh content and to provide the user with engaging content that encourages the user to conduct additional searches.

As used herein, a topic of a recommended story: for example, “Midwest storm”, “Old man dies” are topics that might be recommended on a given day the events occurred. A category of a recommended story includes Sports, Politics, Entertainment, etc. An entity is the dominant entity of the story, for example, a story of “Actress A's misbehavior”—the dominant entity is Actress A. Similarly, in the story “Actress IDs suspect” the main entity in question can be the name of the actress.

The disclosed architecture is an enhancement to a search engine that enables the search engine to unobtrusively understand the concepts and entities the user considers of interest, while simultaneously understanding and identifying the events in the world at the present time. These concepts/entities and current events are then mapped to each other to provide a personalized experience for each user that is informative as to the latest news of interest to the user. This is provided not as a separate service, but as part of the user's search experience.

The disclosed architecture utilizes a knowledge base of a search engine about a given user to identify and understand specific interests of the user in terms of entities or concepts, such as the celebrities of interest, the technologies of interest, politicians to follow, etc., using all available data sources such as search history, browsing history, social networking activity (e.g., user actions on social websites such as “likes”, comments, and messages) compiled from the user's social graph.

The importance of these entities to the user can be ranked by frequency and variety. Thus, a user's single search for a specific location does not necessarily mean the location is identified as an interest; however, multiple queries about related entities may indicate strength (or importance) of the interest. Other indicators of strength of interest can include browsing history, comments, “likes” on a social network, and click-through rates, for example.

The disclosed architecture utilizes the understanding of concepts by the search engine to analyze current events and match the current events to concepts (topics) and entities. The popular queries are combined with the understanding of what is being indexed in a super fresh tier (e.g., from seconds ago) to determine the current events, rather than having popular queries at a specific time based on overall usage patterns using search terms that other users are currently querying to identify what is popular, and thereby only relying on people searching for things. The importance of the information being indexed can also be ranked through clustering of the information (using commonly-known clustering algorithms) to understand the “breaking news”, for example, that many websites are discussing, as opposed to a single user's latest blog post.

The user interests are mapped to current events, and queries are formulated, ranked, and displayed to the user that relate to what the user may be interested in searching about new events the user would not have considered without the search engine's help. This drives a higher query rate and increased engagement with the search engine.

Users are encouraged to use the search engine more consistently for searches, since the increased use provides a correspondingly increased understanding the search engine has of the user interests. Moreover, the user can modify the associated user interests or exclude concepts, as an option. This is similar to deleting items from the user search history if the user believes items of the search history are not relevant.

The following describe in greater detail the types of social networking activity that can be utilized to map to entities and extract user interests: the user “likes” of a social network of public pages or public comments, the user's @PersonName or hashtag #event comments in social network feeds or public pages, as well as, more generally, the content users are commenting about the most at a specific point in time and the pages the commenters follow: user “tweets” (from Twitter™), the hashtags that identify what the user is talking about or referring to (e.g., #elections2012), who the user is following, who the user frequently re-tweets or refers to in their tweets, and others.

These items can be used to not only understand what the user is interested in, but also what is happening in the world now and what is trending or most significant to users, and all of which can be translated into entities. For example, use the social identifier (ID) to map concepts which users are interested in; use the social graph to understand in greater detail what users are interested in (e.g., public likes, re-tweets, etc.); use the broad social activity on social networks to determine what topics/concepts to recommend; and use social activity to detect themes which define the granularity of topics/categories.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

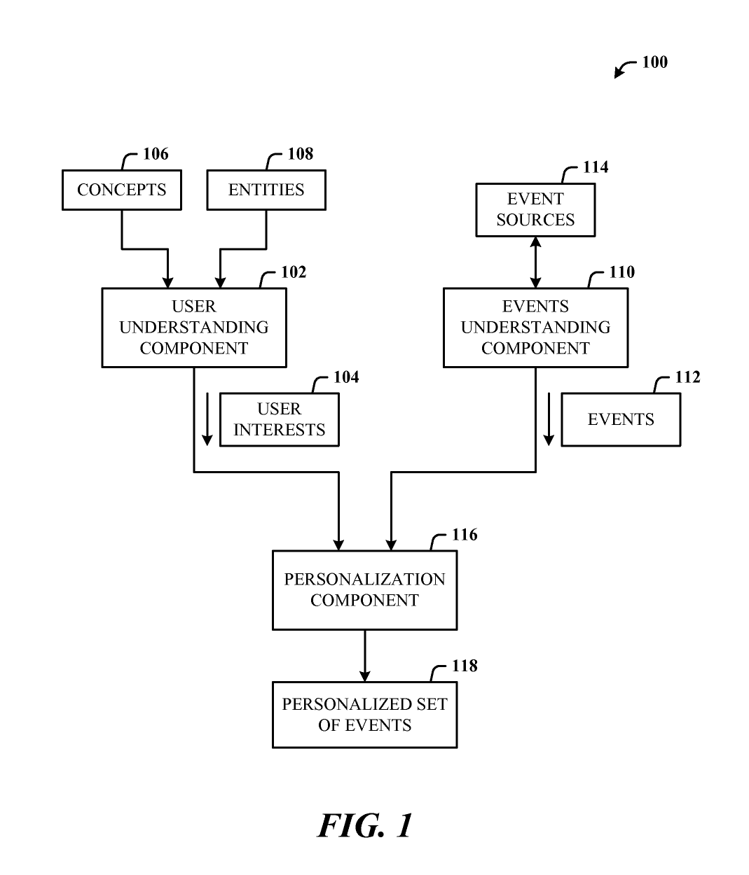

FIG. 1 illustrates a system 100 in accordance with the disclosed architecture. The system 100 can include a user understanding component 102 that identifies user interests 104 of a user based on concepts 106 and entities 108 derived from user activities. An events understanding component 110 identifies events 112 relative to a point in time (e.g., now, yesterday, past week, etc.). The events are obtained from event sources 114 such as websites that provide event information such as news, for example. A personalization component 116 automatically creates a personalized set of events 118 relative to the point in time based on matches computed between the events 112 and the user interests 104. The personalized set of events 118 (e.g., news) is presented for user interaction via a user interface (e.g., a browser).

The user understanding component 102 identifies the user interests 104 based on sources that include user search history (of a browser and/or online server), social interests (of social networks or other social sources), and browsing trends (as identified by the client browser and/or a cloud service). The events understanding component 110 identifies the events 112 based on an index of recent events and events derived from social feeds. The events can be obtained from a number of news websites, sports websites, stock market websites, entertainment websites, weather websites, traffic websites, etc.

The user understanding component 102 performs entity lookup and aggregation of user interests to output a list of entities for personalization, ranking, and selection by the personalization component 116. The personalization component 116 performs entity aggregation and matching of entities to the events 112 based on a list of entities related to user interests 104 and a list of entities related to events 112.

The events 112 are most recent news events within a time span of a point in time. In other words, the recent news events can be events that have occurred in the most recent time span of twenty-four hours from the current time (the point in time), two days, one week, etc. The user interests are mapped to current events, and new queries for new events are formulated and presented for recommendation to the user for user interaction. For example, if the events of interest to the user are dominated by sports events, then new sports events can be generated and suggested for the user. In another example, if the user interest is mapped to ice hockey, a new query formulated and suggested to the user may be field hockey.

The events understanding component identifies popular queries of a network, obtains document results for the queries, maps words of the document results to topics, derives concepts for the topics, and stores a concept profile in association with the user. In other words, find topics that are “spiking” (the most popular for a given period of time, e.g., current time) on the web (the Internet). Some of these events are relevant to the user interests and are to be recommended. Then analyze the search terms (queries) that are spiking as well, to derive the top set of queries that are spiking on the web. The spiking queries are submitted to a search engine, and the documents for those queries are returned as search results. A search result includes at least a title, link to the document, and a snippet (or small section or word sets) of text from the document. A topic mapper than analyzes the snippet text and maps a topic to the document. A mapping can be applied to every possible word of the snippet of the document. A concept can then be selected for the topic. The concepts for the results are then stored online as a profile of concepts the user has clicked on (e.g., in the last 30-40 days). Thus, any document that maps to that concept profile is presented to the user as a search result on the SERP (search engine results page).

In an alternative embodiment, spiking topics are derived, documents having text about the topics are found, and key concepts are extracted from the topics. It is possible to perform the mapping without the user understanding part.

Other sources of data that can be obtained to understand the user include, but are not limited to, check-in data, geographic location data, user actions on a user device, repetitive user actions on devices, program and/or data downloads, emails, messaging, and so on.

The system 100 can also employ a privacy component (not shown) for authorized and secure handling of user information and personally identifiable information. The privacy component allows the subscriber to opt-in and opt-out of tracking information such as user activities and entities as well as personal information that may have been obtained.

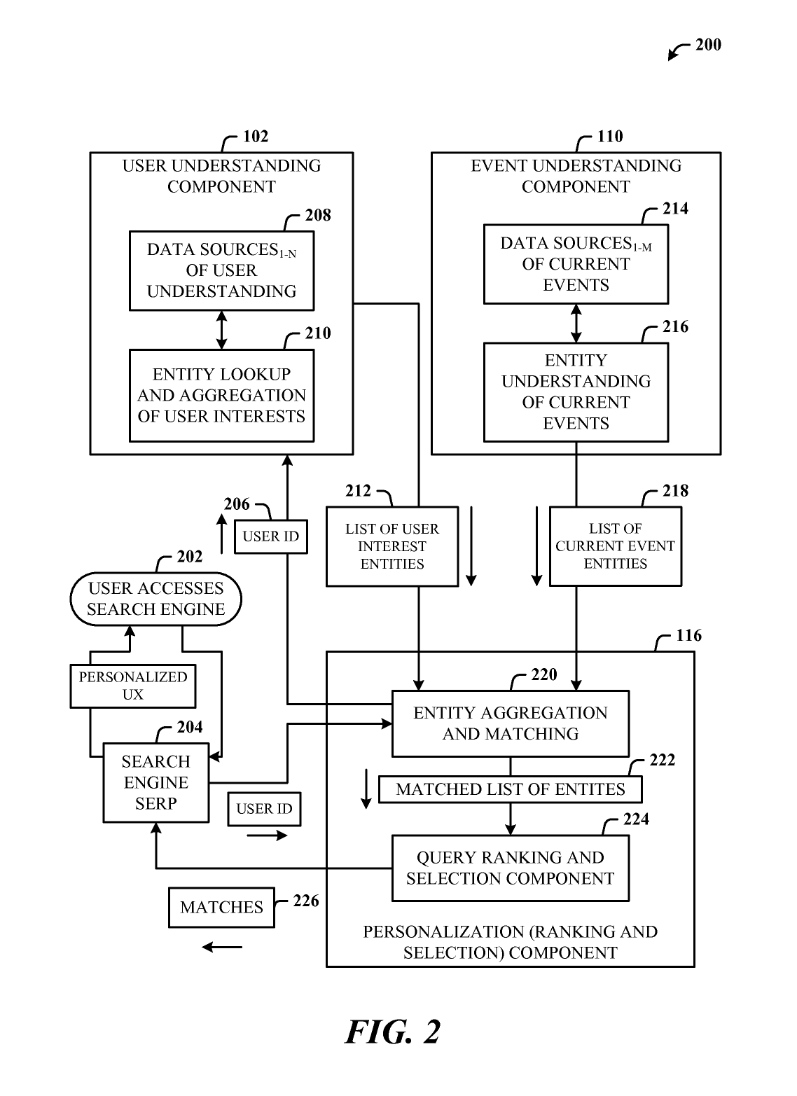

FIG. 2 illustrates a system 200 that facilitates a personalized search experience. The system 200 comprises the user understanding component 102, the event understanding component 110, and the personalization component 116. In operation, as a user accesses a search engine, at 202, the user is presented with a search results page 204 that can include the homepage, search results, and other verticals. A user identifier (ID) 206 is generated and passed to the personalization component 116 and the user understanding component 102.

The user understanding component 102 accesses data sources of user understanding 208 (based on the user ID) such as user search history, social interests (e.g., as determined from social networks), and browsing trends of the user. From these sources 208 the user understanding component 102 performs entity lookup aggregation and aggregation of user interests using a module 210. The output of the user understanding component 102 is a list of user interest entities 212 passed to the personalization component 116.

The event understanding component 110 accesses data sources of current events 214 such as a “super fresh” index of event information (e.g., breaking news, occurring events, events that have occurred in a recent span of time (e.g., a few hours, a few days, etc.), and data sources such as social feeds from social networks. The index can be populated based on events obtained from news websites or other websites that provide events of interest, such as entertainment websites, sports websites, and so on. The social feeds can provide trending events as based on social activities/actions of other users.

The output of the data sources of current events 214 is entities related to these events. These entities are analyzed (processed) according to an entity understanding of current events module 216. An output of the events understanding component 110 is then a list of current event entities 218, which is then passed to the personalization component 116.

The personalization component 116 then performs entity aggregation and matching using a module 220, which outputs a matched list of entities 222, as sent to a query ranking and selection component 224. The output of the query ranking and selection component 224 is a set of matches 226, which are input to the search engine results page (SERP) 204, and then presented to the user, at 202.

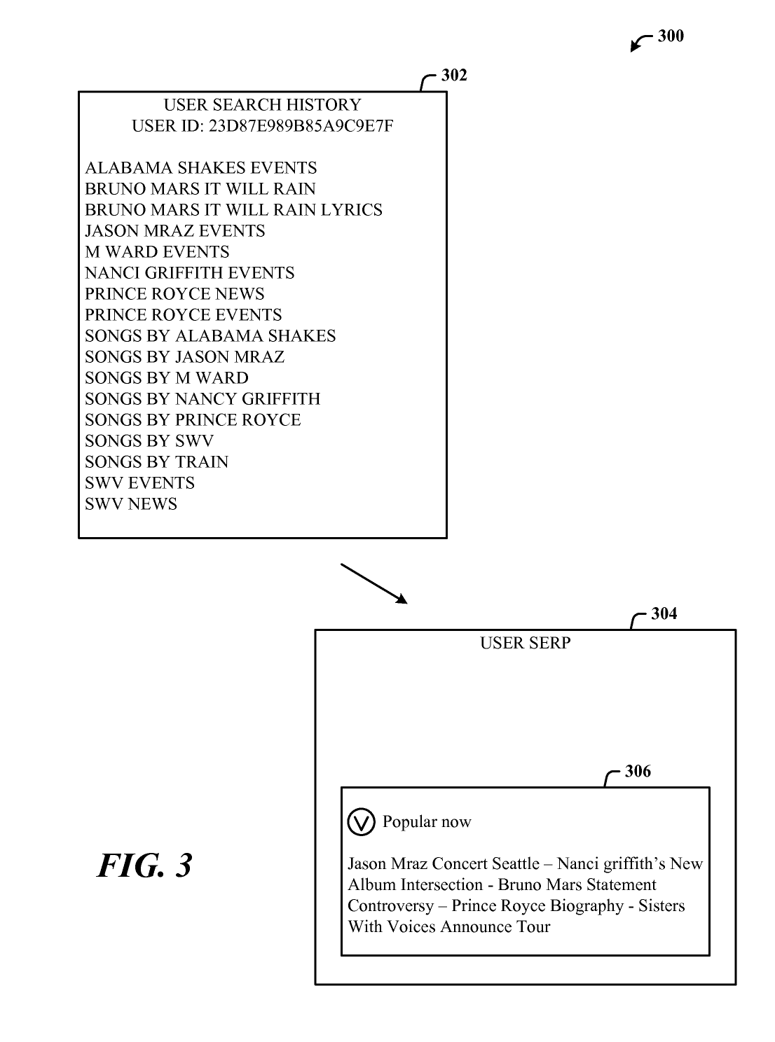

FIG. 3 illustrates an example of a personalized search experience 300 in accordance with the disclosed architecture. Here, the source of user understanding is the user search history 302, as relates to an anonymized (made anonymous by some technique) user ID. The search history 302 as shown primarily relates to music, musicians, and musical groups, and events related to specific entities. Accordingly, the disclosed architecture generates as search engine results page (SERP) 304 to include a Popular Now section 306 populated and personalized with the latest happening for these public figures (and some generally Popular Now information integrated into this list—not shown). Thus, when the user selects one of the queries in the section 306, there is “super fresh” result (e.g., last few hours, last few days, etc.) returned.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

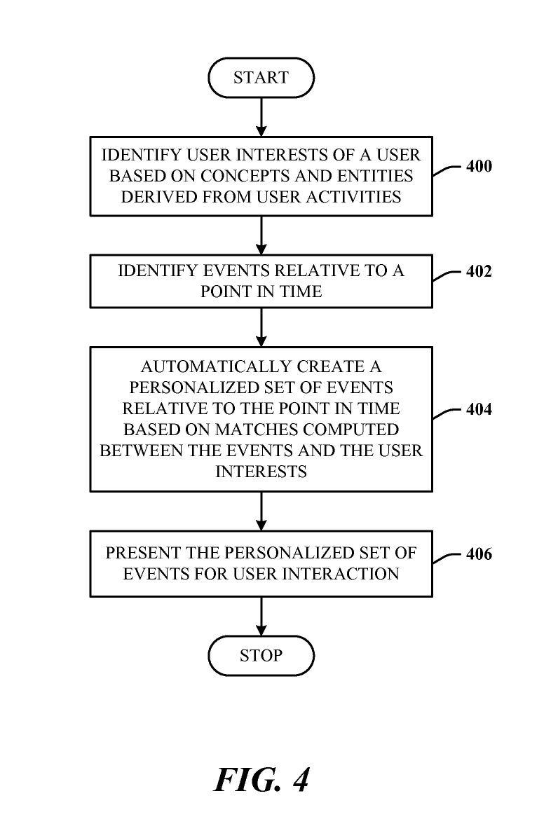

FIG. 4 illustrates a method in accordance with the disclosed architecture. At 400, user interests of a user are identified based on concepts and entities derived from user activities. At 402, events relative to a point in time are identified. At 404, a personalized set of events relative to the point in time is automatically created based on matches computed between the events and the user interests. At 406, the personalized set of events is presented for user interaction.

The method can further comprise generating and presenting new queries based on the personalized set of events and user interests. The method can further comprise computing importance values for the entities as related to the user and ranking the entities according to the importance values. The method can further comprise identifying the concepts and entities based on at least one of user search history, browsing activity, or social network activity.

The method can further comprise enabling the user to modify the user interests and exclude concepts. The method can further comprise creating the personalized set of events based in part on correlation of popular queries as relate to an index of events that occur within a recent span of time relative to the point in time, which point in time is current time. The method can further comprise identifying social network activities and relating the activities to the entities for identifying the user interests.

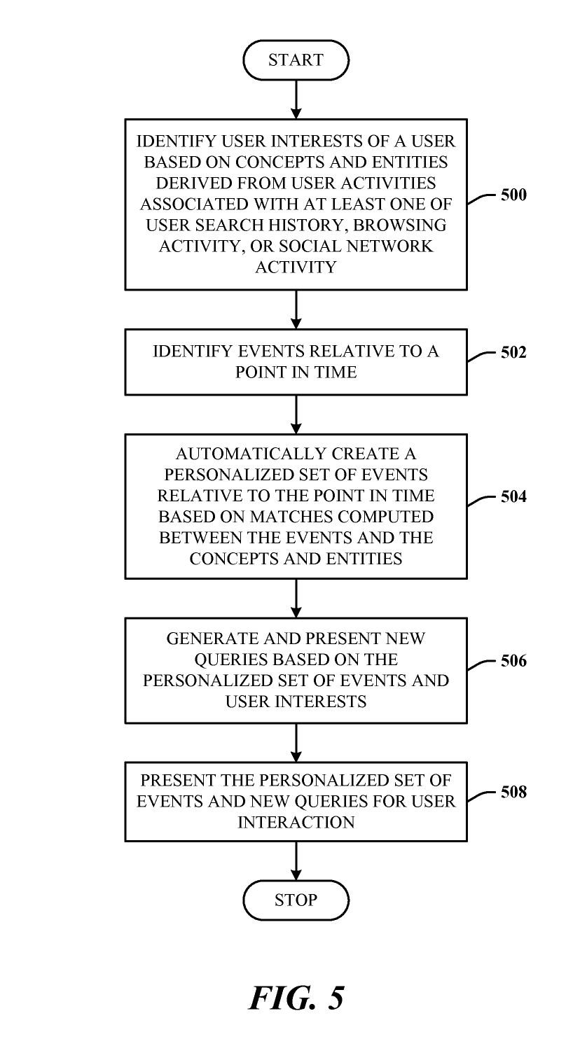

FIG. 5 illustrates an alternative method in accordance with the disclosed architecture. At 500, user interests of a user are identified based on concepts and entities derived from user activities associated with at least one of user search history, browsing activity, or social network activity. At 502, events relative to a point in time are identified. At 504, a personalized set of events relative to the point in time are automatically created based on matches computed between the events and the concepts and entities. At 506, new queries are generated based on the personalized set of events and user interests. At 508, the personalized set of events and new queries are presented for user interaction.

The method can further comprise ranking the entities based on frequency of entity interaction and variety of the entities. The method can further comprise mapping the user interests to related current events, formulating new queries about other new events, and presenting the new queries about the other new events for user interaction. The method can further comprise indexing current events and ranking the indexed current events based on a clustering technique to determine at least one of most recent events or occurring events. The method can further comprise analyzing social activity of social network to determine concepts and topics to recommend.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

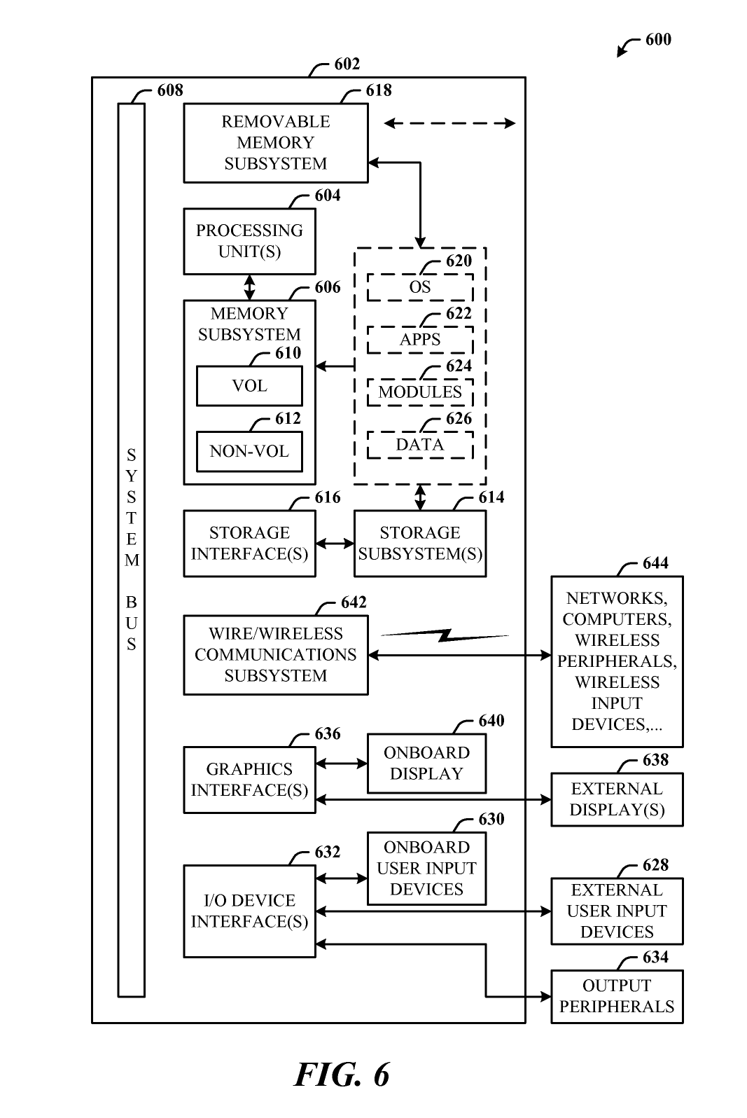

Referring now to FIG. 6, there is illustrated a block diagram of a computing system 600 that generates and executes identification of user interests and matching events for a personalized search experience in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 6 and the following description are intended to provide a brief, general description of the suitable computing system 600 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 600 for implementing various aspects includes the computer 602 having processing unit(s) 604 (also referred to as microprocessor(s) and processor(s)), a computer-readable storage medium such as a system memory 606 (computer readable storage medium/media also include magnetic disks, optical disks, solid state drives, external memory systems, and flash memory drives), and a system bus 608. The processing unit(s) 604 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 602 can be one of several computers employed in a datacenter and/or computing resources (hardware and/or software) in support of cloud computing services for portable and/or mobile computing systems such as cellular telephones and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 606 can include computer-readable storage (physical storage) medium such as a volatile (VOL) memory 610 (e.g., random access memory (RAM)) and a non-volatile memory (NON-VOL) 612 (e.g., ROM, EPROM, EEPROM, etc.). A basic input/output system (BIOS) can be stored in the non-volatile memory 612, and includes the basic routines that facilitate the communication of data and signals between components within the computer 602, such as during startup. The volatile memory 610 can also include a high-speed RAM such as static RAM for caching data.

The system bus 608 provides an interface for system components including, but not limited to, the system memory 606 to the processing unit(s) 604. The system bus 608 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 602 further includes machine readable storage subsystem(s) 614 and storage interface(s) 616 for interfacing the storage subsystem(s) 614 to the system bus 608 and other desired computer components. The storage subsystem(s) 614 (physical storage media) can include one or more of a hard disk drive (HDD), a magnetic floppy disk drive (FDD), solid state drive (SSD), and/or optical disk storage drive (e.g., a CD-ROM drive DVD drive), for example. The storage interface(s) 616 can include interface technologies such as EIDE, ATA, SATA, and IEEE 1394, for example.

One or more programs and data can be stored in the memory subsystem 606, a machine readable and removable memory subsystem 618 (e.g., flash drive form factor technology), and/or the storage subsystem(s) 614 (e.g., optical, magnetic, solid state), including an operating system 620, one or more application programs 622, other program modules 624, and program data 626.

The operating system 620, one or more application programs 622, other program modules 624, and/or program data 626 can include items and components of the system 100 of FIG. 1, items and components of the system 200 of FIG. 2, the personalized search experience 300 of FIG. 3, and the methods represented by the flowcharts of FIGS. 4 and 5, for example.

Generally, programs include routines, methods, data structures, other software components, etc., that perform particular tasks or implement particular abstract data types. All or portions of the operating system 620, applications 622, modules 624, and/or data 626 can also be cached in memory such as the volatile memory 610, for example. It is to be appreciated that the disclosed architecture can be implemented with various commercially available operating systems or combinations of operating systems (e.g., as virtual machines).

The storage subsystem(s) 614 and memory subsystems (606 and 618) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 602, and include volatile and non-volatile internal and/or external media that is removable and/or non-removable. For the computer 602, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 602, programs, and data using external user input devices 628 such as a keyboard and a mouse, as well as by voice commands facilitated by speech recognition. Other external user input devices 628 can include a microphone, an IR (infrared) remote control, a joystick, a game pad, camera recognition systems, a stylus pen, touch screen, gesture systems (e.g., eye movement, head movement, etc.), and/or the like. The user can interact with the computer 602, programs, and data using onboard user input devices 630 such a touchpad, microphone, keyboard, etc., where the computer 602 is a portable computer, for example.

These and other input devices are connected to the processing unit(s) 604 through input/output (I/O) device interface(s) 632 via the system bus 608, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 632 also facilitate the use of output peripherals 634 such as printers, audio devices, camera devices, and so on, such as a sound card and/or onboard audio processing capability.

One or more graphics interface(s) 636 (also commonly referred to as a graphics processing unit (GPU)) provide graphics and video signals between the computer 602 and external display(s) 638 (e.g., LCD, plasma) and/or onboard displays 640 (e.g., for portable computer). The graphics interface(s) 636 can also be manufactured as part of the computer system board.

The computer 602 can operate in a networked environment (e.g., IP-based) using logical connections via a wired/wireless communications subsystem 642 to one or more networks and/or other computers. The other computers can include workstations, servers, routers, personal computers, microprocessor-based entertainment appliances, peer devices or other common network nodes, and typically include many or all of the elements described relative to the computer 602. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 602 connects to the network via a wired/wireless communication subsystem 642 (e.g., a network interface adapter, onboard transceiver subsystem, etc.) to communicate with wired/wireless networks, wired/wireless printers, wired/wireless input devices 644, and so on. The computer 602 can include a modem or other means for establishing communications over the network. In a networked environment, programs and data relative to the computer 602 can be stored in the remote memory/storage device, as is associated with a distributed system. It will be appreciated that the network connections shown are exemplary and other means of establishing a communications link between the computers can be used.

The computer 602 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a user understanding component that identifies user interests of a user based on concepts and entities derived from user activities;
an events understanding component that identifies events relative to a point in time;
a personalization component that automatically creates a personalized set of events relative to the point in time based on matches computed between the events and the user interests, the personalized set of events presented for user interaction; and
a microprocessor that executes computer-executable instructions associated with at least one of the user understanding component, the events understanding component, or the personalization component.

2. The system of claim 1, wherein the user understanding component identifies the user interests based on sources that include user search history, social interests, and browsing trends.

3. The system of claim 1, wherein the events understanding component identifies the events based on an index of recent events and events derived from social feeds.

4. The system of claim 1, wherein the user understanding component performs entity lookup and aggregation of user interests to output a list of entities for personalization, ranking, and selection by the personalization component.

5. The system of claim 1, wherein the personalization component performs entity aggregation and matching of entities to the events based on a list of entities related to user interests and a list of entities related to events.

6. The system of claim 1, wherein the events are most recent news events within a time span of a point in time.

7. The system of claim 1, wherein the user interests are mapped to current events, and new queries for new events are formulated and presented for recommendation to the user for user interaction.

8. The system of claim 1, wherein the events understanding component identifies popular queries of a network, obtains document results for the queries, maps words of the document results to topics, derives concepts for the topics, and stores a concept profile in association with the user.

9. A method, comprising acts of:
identifying user interests of a user based on concepts and entities derived from user activities;
identifying events relative to a point in time;
automatically creating a personalized set of events relative to the point in time based on matches computed between the events and the user interests; and
presenting the personalized set of events for user interaction.

10. The method of claim 9, further comprising generating and presenting new queries based on the personalized set of events and user interests.

11. The method of claim 9, further comprising computing importance values for the entities as related to the user and ranking the entities according to the importance values.

12. The method of claim 9, further comprising identifying the concepts and entities based on at least one of user search history, browsing activity, or social network activity.

13. The method of claim 9, further comprising enabling the user to modify the user interests and exclude concepts.

14. The method of claim 9, further comprising creating the personalized set of events based in part on correlation of popular queries as relate to an index of events that occur within a recent span of time relative to the point in time, which point in time is current time.

15. The method of claim 9, further comprising identifying social network activities and relating the activities to the entities for identifying the user interests.

16. A computer-readable medium comprising computer-executable instructions that when executed by a processor, cause the processor to perform acts of:
identifying user interests of a user based on concepts and entities derived from user activities associated with at least one of user search history, browsing activity, or social network activity;
identifying events relative to a point in time;
automatically creating a personalized set of events relative to the point in time based on matches computed between the events and the concepts and entities;
generating new queries based on the personalized set of events and user interests; and
presenting the personalized set of events and new queries for user interaction.

17. The computer-readable medium of claim 16, further comprising ranking the entities based on frequency of entity interaction and variety of the entities.

18. The computer-readable medium of claim 16, further comprising mapping the user interests to related current events, formulating new queries about other new events, and presenting the new queries about the other new events for user interaction.

19. The computer-readable medium of claim 16, further comprising indexing current events and ranking the indexed current events based on a clustering technique to determine at least one of most recent events or occurring events.

20. The computer-readable medium of claim 16, further comprising analyzing social activity of social network to determine concepts and topics to recommend.
